(19) United States
(12) Patent Application Publication
(10) Pub. No.: US 2015/0039659 A1
(43) Pub. Date: Feb. 5, 2015

(54) DATA LOCATION MANAGEMENT AGENT USING REMOTE STORAGE

(71) Applicants: William F. Sauber, Georgetown, TX (US); Munif M. Farhan, Round Rock, TX (US)

(72) Inventors: William F. Sauber, Georgetown, TX (US); Munif M. Farhan, Round Rock, TX (US)

(21) Appl. No.: 13/954,450

(22) Filed: Jul. 30, 2013

(51) Int. Cl. G06F 17/30

(52) U.S. Cl. CPC G06F 17/30091; G06F 17/30117
USPC 707/827

(57) ABSTRACT

Methods and systems for offloading data to a remote storage resource from a local storage resource on an information handling system may involve using a data location management agent and an offload mapping. The data location management agent may detect requests for access to files stored on a file system and may offload files to the remote storage resource to maintain a specified available capacity of the local storage resource, based on at least in part on the offload mapping. The data location management agent may classify certain files as pinned files that are excluded from offloading.

### BACKGROUND

1. Field of the Disclosure

This disclosure relates generally to information handling systems and more particularly to a data location management agent using remote storage.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system may vary in terms of persistent storage capacity (also referred to herein simply as “storage”). For example, certain portable information handling systems, among other types of information handling systems, such as those configured in the form of laptop, notebook, netbook, and/or tablet computers, in addition to cellular phones, smart phones, portable digital assistants (PDA), media players, and/or other types of mobile communication devices, may be constrained in an available storage capacity accessible by a user of the information handling system. The storage constraint may undesirably limit the user's ability to access to applications and data. In certain instances, the storage constraint may be alleviated using remote storage services provided by a server via a network accessible to the information handling system.

However, the use of available remote storage solutions may be associated with certain disadvantages for the user. For example, a response time (i.e., latency), data transfer speeds, a cost of data transfer, and/or a management effort for implementing remote storage on an information handling system may involve undesirable and/or inconvenient aspects for the user.

### SUMMARY

In one aspect, a disclosed method executed by at least one processor includes detecting, by a data location management agent installed on an information handling system, a request to access a first data file intended for a local storage resource included with the information handling system. When the first data file is currently stored at a remote storage resource accessible to the information handling system, the method may include offloading at least a second data file to the remote storage resource, including deleting the second data file from the local storage resource, and loading the first data file from the remote storage resource to the local storage resource.

Other disclosed aspects include an article of manufacture comprising a non-transitory computer-readable medium storing instructions executable by a processor subsystem, and an information handling system comprising a processor subsystem having access to a memory subsystem storing instructions executable by the processor subsystem.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 is a block diagram of selected elements of an embodiment of data and code stored on an information handling system;

FIG. 3 is a block diagram of selected elements of an embodiment of data stored in an offload mapping;

FIG. 4 is flowchart depicting selected elements of an embodiment of a method for offloading data;

FIG. 5 is flowchart depicting selected elements of an embodiment of a method for offloading data; and

FIG. 6 is flowchart depicting selected elements of an embodiment of a method for offloading data.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components. Additionally, the information handling system may include firmware for controlling and/or communicating with, for example, hard drives, network circuitry, memory devices, I/O devices, and other peripheral devices.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

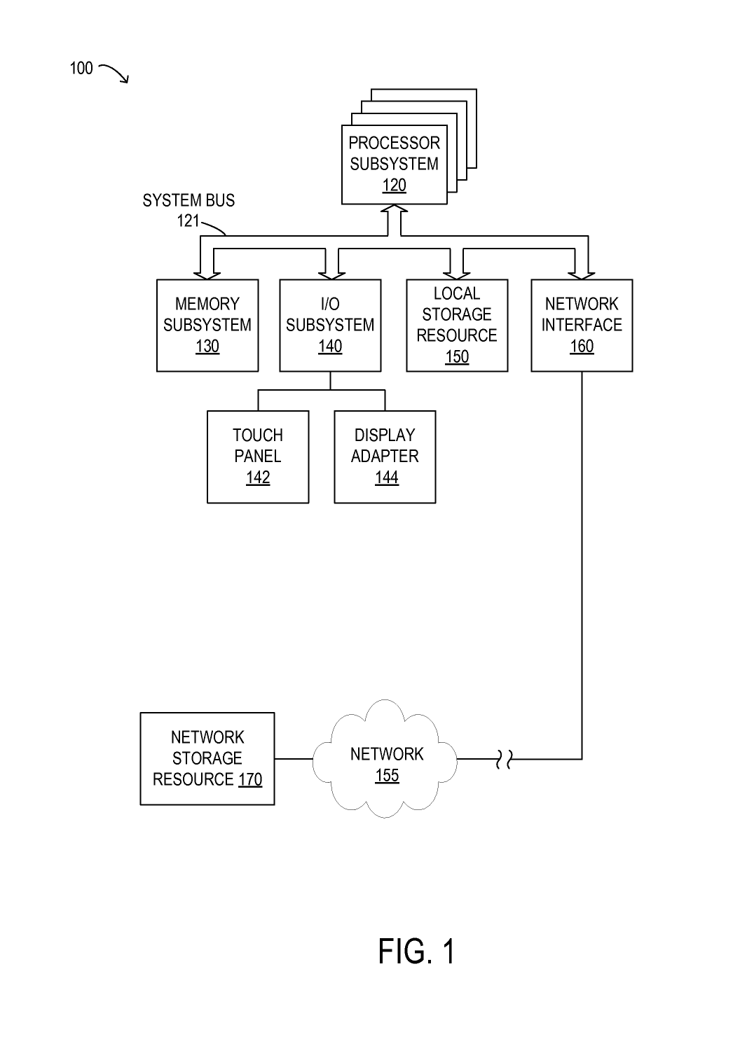

Particular embodiments are best understood by reference to FIGS. 1, 2, 3, 4, 5, and 6 wherein like numbers are used to indicate like and corresponding parts.

Turning now to the drawings, FIG. 1 illustrates a block diagram depicting selected elements of an embodiment of information handling system 100 for data offloading, as described herein. In particular embodiments, information handling system 100 may represent a portable information handling system.

As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Peripheral Component Interconnect (PCI), PCI-Express, and HyperTransport (HT), among others.

In FIG. 1, network interface 160 may be a suitable system, apparatus, or device operable to serve as an interface between information handling system 100 and a network 155. Network interface 160 may enable information handling system 100 to communicate over network 155 using a suitable transmission protocol and/or standard, including, but not limited to, transmission protocols and/or standards enumerated below with respect to the discussion of network 155. In some embodiments, network interface 160 may be communicatively coupled via network 155 to network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 155 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, or any combination thereof.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of physical hardware 102). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down. Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, network storage resource 170 may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data. In system 100, I/O subsystem 140 may comprise a system, device, or apparatus generally operable to receive and/or transmit data to/from/within system 100. I/O subsystem 140 may represent, for example, a variety of communication interfaces, graphics interfaces, video interfaces, user input interfaces, and/or peripheral interfaces. As shown, I/O subsystem 140 may comprise touch panel 142 and display adapter 144. Touch panel 142 may include circuitry for enabling touch functionality in conjunction with a display for (not shown) that is driven by display adapter 144.

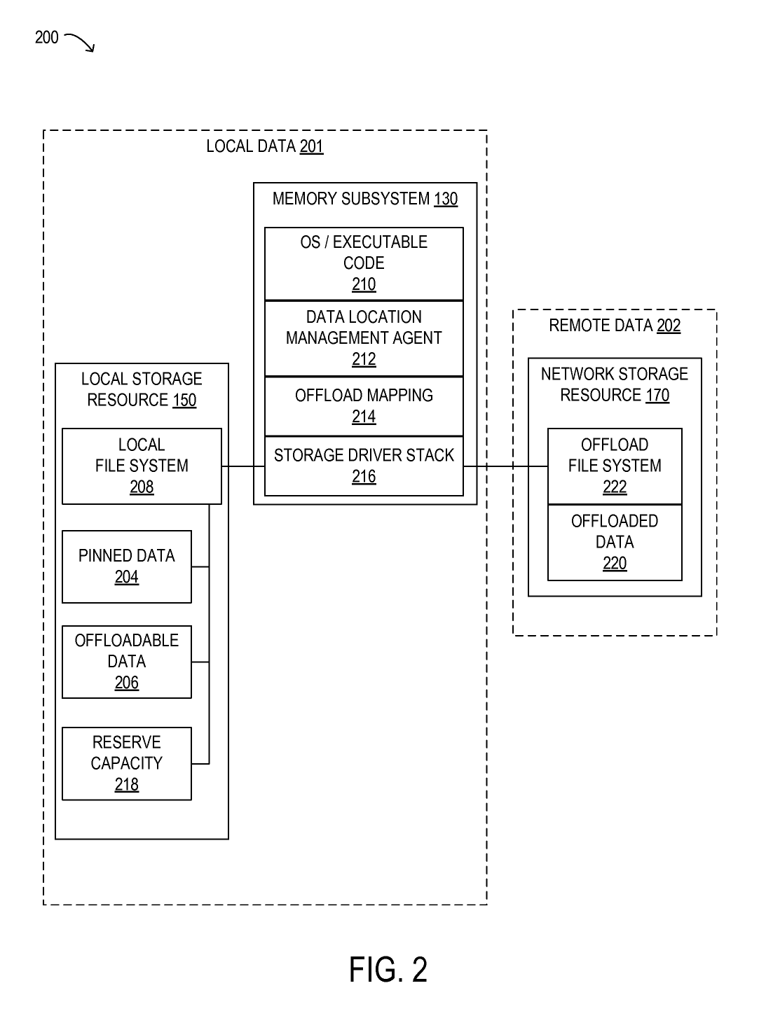

In operation of information handling system 100 shown in FIG. 1, local storage resource 150 may store various types of data, such as, but not limited to, an operating system (OS) and associated data, application data, user data, and other types of data, including executable program instructions that may be loaded into memory subsystem 130 for access and execution by processor subsystem 120. Local storage resource 150 may represent a dedicated non-volatile storage resource included with information handling system 100. In certain configurations and scenarios, a storage capacity of local storage resource 150 may be constrained, for example, when a physical capacity of local storage resource 150 has been consumed by data stored thereon. As will be described in further detail herein, information handling system 100 may be equipped with a data location management agent (not shown in FIG. 1, see FIG. 2, data location management agent 212) that includes executable code for offloading data from local storage resource 150 to network storage resource 170 in a manner that is largely automatic and transparent to the user. In this manner, the data location management agent, as described herein, may provide the user with the ability to access much larger storage capacity than provided by local storage resource 150, while providing an offload storage mechanism that is cost-effective and practical to use.

Turning now to FIG. 2, a block diagram of selected elements of an embodiment of information handling system 200 is illustrated. In FIG. 2, information handling system 200 may represent an information handling system that is an embodiment of information handling system 100 (see FIG. 1). As shown, information handling system 200 includes further details regarding various types of local data 201, such as data locally present on information handling system 100, and remote data 202 stored on network storage resource 170.

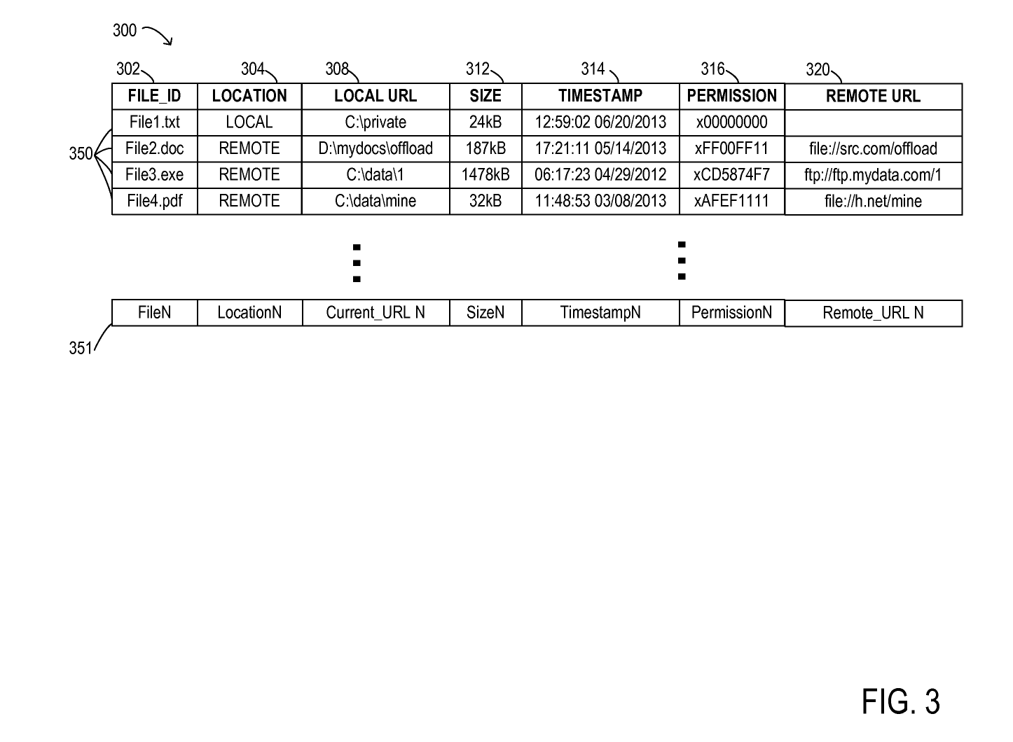

In FIG. 2, local data 201 is shown comprising data loaded on memory subsystem 130 as well as data loaded on local storage resource 150. It will be appreciated that memory subsystem 130 may store data in a form accessible to processor subsystem 120 (see FIG. 1) and may accordingly store data in the form of processor-executable instructions. As shown, memory subsystem 130 may include OS/executable code 210 representing an operating system and executable code in the form of applications and/or other programs executing under the operating system. The operating system represented by OS/executable code 210 may be a UNIX or UNIX-like operating system, a Windows® family operating system, a mobile device operating system (such as a version of iOS (Apple Inc.) or a version of Android (Google Inc.)), and/or another suitable operating system, and/or various components thereof. The executable code represented by OS/executable code 210 may include various types of user applications, services, communication applications, apps, and/or various components thereof. Specifically shown in FIG. 2 is data location management agent 212, which may be enabled to offload data according to the methods described herein, and which may access offload mapping 214 (see also FIG. 3) for performing offload operations and decisions. Also shown is storage driver stack 216, which may represent a number of layers in a network software model for accessing external devices and/or resources. In particular, storage driver stack 216 may provide a communication avenue for data location management agent 212 to access data stored on local storage resource 150 using local file system 208 and to access data stored on remote storage resource 170 using offload file system 222.

As shown in FIG. 2, local storage resource 150 may be configured with local file system 208, which may be supported by (or be compatible with) OS/executable code 210. Local file system 208 may organize a storage capacity of local storage resource 150 to enable access to data stored thereon using logical entities, such as directories and filenames. In FIG. 2, local file system 208 may store pinned data 204, offloadable data 206, and may have available capacity for storing additional data, represented by reserve capacity 218. As will be described in further detail, data location management agent 212 may be configured to maintain an available capacity on local storage resource 150 under local file system 208 that is at least a specified value represented by reserve capacity 218. In other words, data location management agent 212 may be configured to offload offloadable data 206 from local storage resource 150 to maintain reserve capacity 218 on information handling system 200 to enable a desired operational state, for example, to enable reliable behavior and/or a desired performance level of OS/executable code 210. Pinned data 204 may represent data stored under local file system 208 that, by virtue of file type, file extension, location, initial access, and/or suitability, is not included with offloadable data 206, because pinned data 204 is designated for local storage. In FIG. 2, remote data 202 includes offloaded data 220 stored under offload file system 222 at network storage resource 170.

Turning now to FIG. 3, a block diagram of selected elements of an embodiment of offload mapping 300 is illustrated in table format. In FIG. 3, offload mapping 300 may represent a table, a database, a registry, and/or another type of data structure, in various embodiments. As shown, offload mapping 300 includes columns 302-320 representing specific data types and attributes, as well as rows (also known as records or entries), shown as rows 350 of example data up to Nth row 351, where N may be any suitable number. Rows 350 are shown with simplified example data for descriptive clarity, while it will be understood that various types of columns and contents of rows may be implemented in different embodiments (not shown). The data stored in offload mapping 300 may referred to as “metadata” describing files represented in columns 350, 351.

In FIG. 3, column 302 contains FILE_ID, which may be a filename with a file extension; column 304 contains LOCATION, which may indicate whether a file is stored locally or remotely; column 308 contains LOCAL URL, which may be a universal resource locator to a local location of a file; column 312 contains SIZE indicating an amount of storage consumed by a file under a file system; column 314 contains TIMESTAMP indicating a date/time associated with a file (e.g., a timestamp of a most recent access to the file); column 316 contains PERMISSION which may be certain binary values (i.e., flags) shown as an aggregate hexadecimal value containing permission information, such as provided by an operating system and/or a file system; and column 320 contains REMOTE URL, which may be a universal resource locator to a remote location of a file. It is noted that for at least some of the information included in offload mapping 300 (e.g., timestamp 314), data location management agent 212 may optionally reference metadata associated with local file system 208 for a particular file represented by one of rows 350.

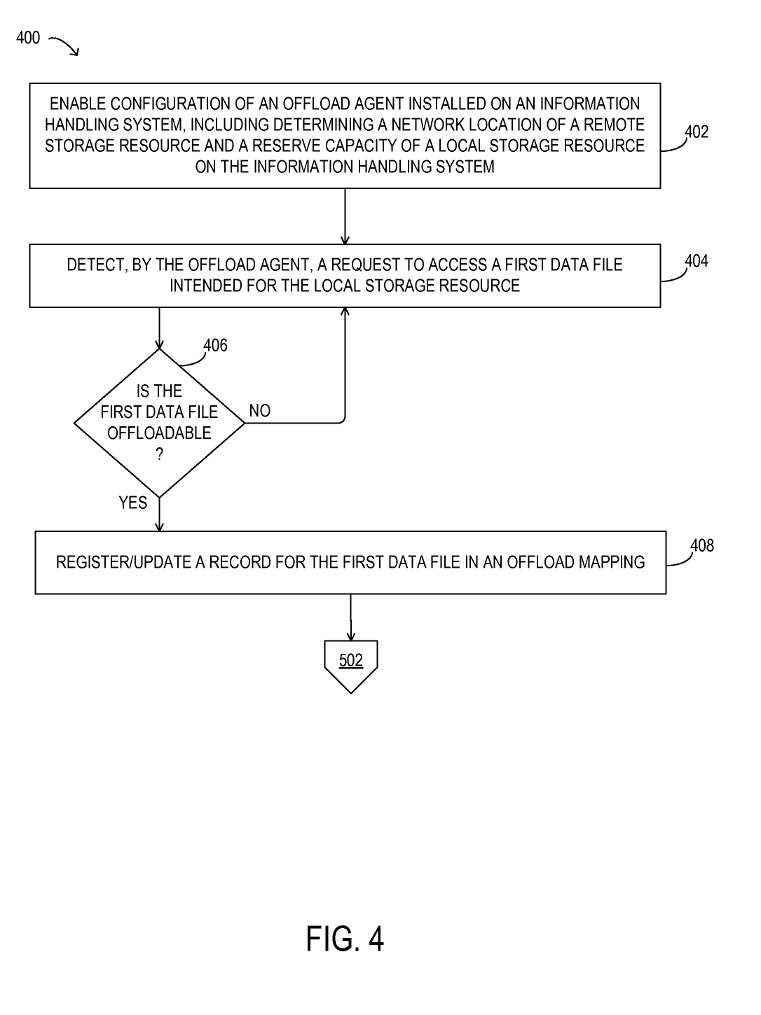

Referring now to FIG. 4, a block diagram of selected elements of an embodiment of method 400 for offloading data as describe herein is depicted in flowchart form. Method 400 may be performed using data location management agent 212 and offload mapping 300 (see FIGS. 2 and 3) for example. It is noted that certain operations described in method 400 may be optional or may be rearranged in different embodiments.

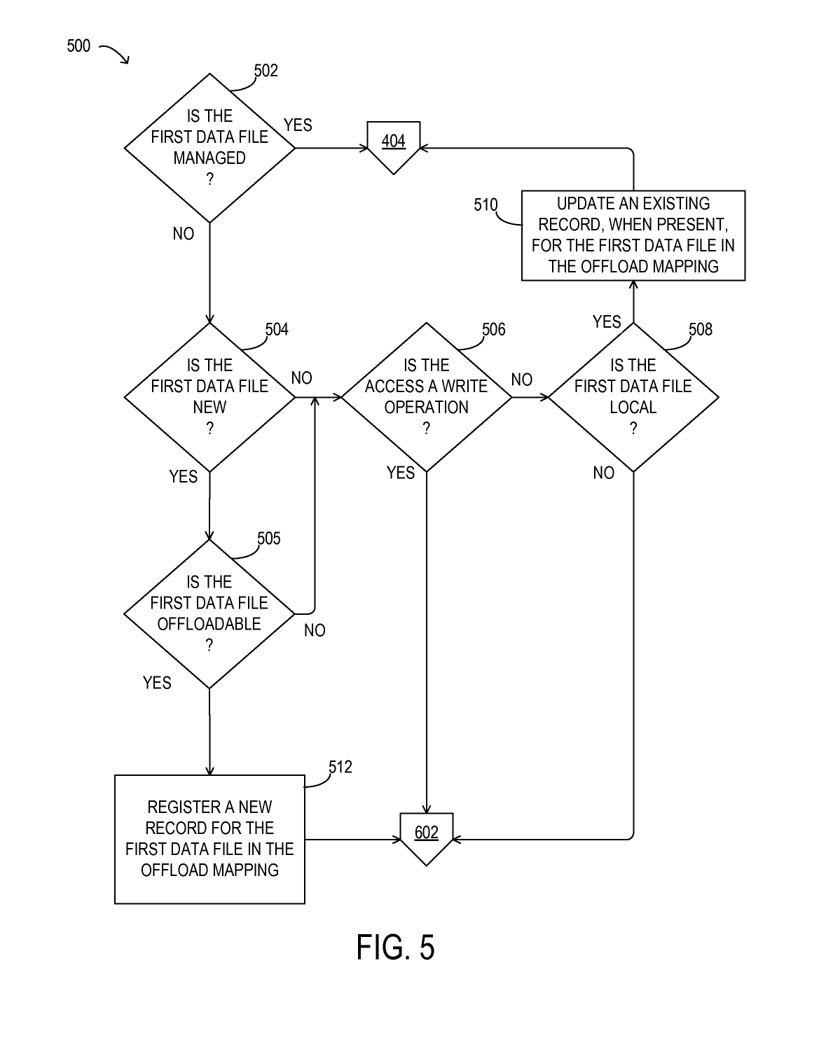

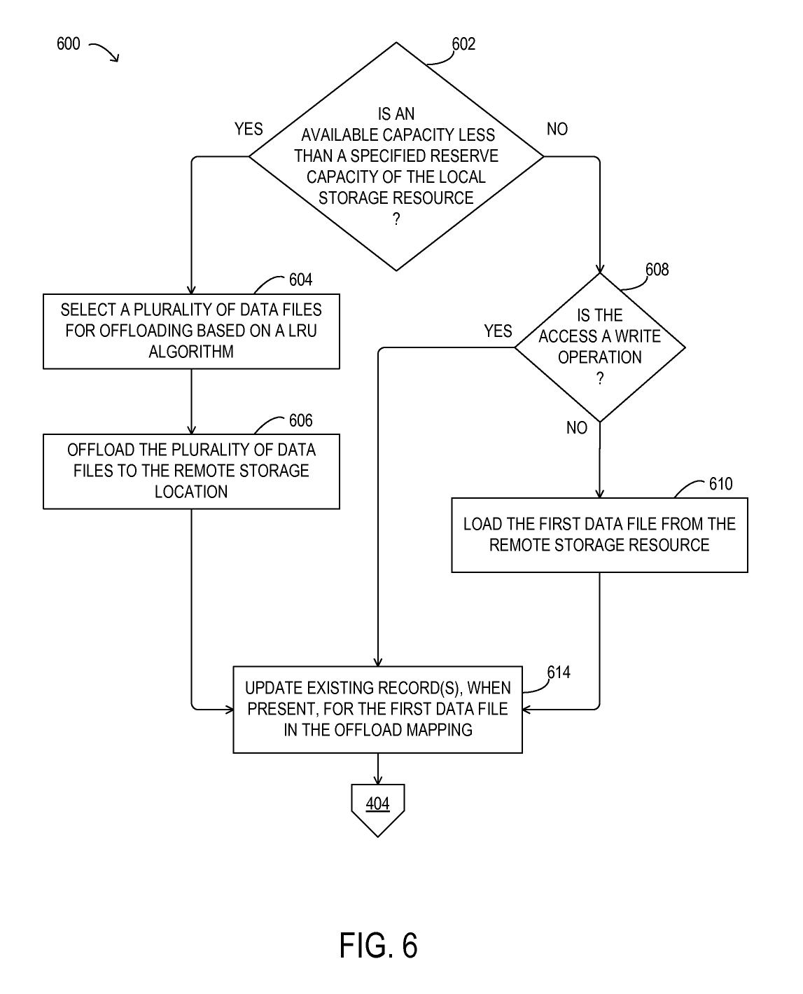

In FIG. 4, method 400 may begin by enabling (operation 402) configuration of a data location management agent installed on an information handling system, including determining a network location of a remote storage resource and a reserve capacity of a local storage resource on the information handling system. It is noted that the configuration enabled in operation 402 may occur by various methods. For example, a manufacturer of an information handling system may load an entire configuration, including a configured data location management agent, at build time, for example, using default values. An administrator of the information handling system may install and/or configure the data location management agent for a user, for example, on behalf of an enterprise or another organization. A user may install and/or configure the data location management agent on a personal device, such as a personal portable information handling system. It is noted that new files created on the information handling system after operation 402 may be offloadable subject to certain other restrictions. Then, a request to access a first data file intended for the local storage resource may be detected (operation 404) by the data location management agent. The first data file may have been previously stored on the local storage resource, but may have already been offloaded. The first data file may be a new or existing file currently stored on the local storage resource. Then a decision may be made whether the first data file is offloadable (operation 406). The decision in operation 406 may be made using offload mapping 300. For example, when the first data file is already included in offload mapping 300, the first data file may be considered offloadable in operation 406. When the first data file is not included in offload mapping 300, the first data file may be offloadable subject to other restrictions. When the result of operation 406 is NO, method 400 may return to operation 404 to await a subsequent request to access a data file. When the result of operation 406 is YES, method 400 may register/update (operation 408) a record for the first data file in an offload mapping. After operation 408, method 400 may proceed to operation 502 in method 500 (see FIG. 5). It is noted that methods 500 and 600 (see FIGS. 5 and 6) provide details on specific exemplary implementations of portions of method 400, such as operations 406 and/or 408. It is further noted that, as methods 500 and 600 return to operation 404, the request to access the first data file may be passed to storage driver stack 216 (see FIG. 2).

Referring now to FIG. 5, a block diagram of selected elements of an embodiment of method 500 for offloading data as described herein is depicted in flowchart form. Method 500 may be performed using data location management agent 212 and offload mapping 300 (see FIGS. 2 and 3) for example. As shown, method 500 may represent a particular embodiment of certain portions of method 400, such as operations 406 and 408 (see FIG. 4). It is noted that certain operations described in method 500 may be optional or may be rearranged in different embodiments.

Method 500 may begin by making a decision whether the first data file is a managed file (operation 502). Certain temporary files created by some applications, such as web browsers, may be classified as managed data files, since the application may already provide a method for managing a total storage consumption, such as a storage consumption of the temporary files. Some operating systems may also include managed files, which may be identified by virtue of a storage location and/or file type of a managed file. Since such managed files may not be considered for offload, they may be considered as being pinned. When the result of operation 502 is YES, method 500 may return to operation 404 (see FIG. 4). When the result of operation 502 is NO, a decision may be made whether the first data file is a new file (operation 504). In operation 504, the decision may be based on whether the first data file is not included in local storage resource 150 and does not have an entry in offload mapping 300. When the result of operation 504 is NO, a decision may be made whether the access to the first data file is a write operation (operation 506). It is noted that a write operation to an unmanaged file may increase a size of the unmanaged file and may result in additional offloading of local files to compensate for the increased storage consumption. When the result of operation 506 is YES, method 500 may proceed to operation 602 in method 600 (see FIG. 6). When the result of operation 506 is NO, a decision may be made whether the first data file is a local file (operation 508). The decision in operation 508 may be based on whether the first data file is locally stored (i.e., is locally resident). When the result of operation 508 is YES, method 500 may update (operation 510) an existing record, when present, for the first data file in the offload mapping. When the first data file is a pinned file, operation 510 may be omitted or may result in no action being performed, because no existing record would exist in offload mapping 300 for a pinned file.

After operation 510, method 500 may return to operation 404 (see FIG. 4), since the first data file is either pinned or is an offloadable file that is resident. When the result of operation 508 is NO, method 500 may proceed to operation 602 in method 600 (see FIG. 6). When the result of operation 504 is YES, the first data file is not yet locally stored and does not have an entry in offload mapping 300, and a decision may be made, whether the first data file is offloadable (operation 505). Operation 505 may include performing additional checks to determine whether the file is offloadable. When the first data file is not offloadable, the first data file may be considered to be pinned. As noted above, certain application files may be classified as pinned files by virtue of their location and/or file type. Determining whether the first data file is pinned may be based on file attributes of the first data file. The file attributes may be selected from (but not limited to): a file extension, a file location in a file system, whether a file includes executable code, attributes of secondary files associated with a file, and/or a security attribute assigned by an operating system installed on the information handling system, and/or other file attributes, such as metadata. Examples of pinned files include new OS files and streaming media files. When the result of operation 505 is NO, then the first data file is a new pinned file, and method 500 may proceed to operation 506. When the result of operation 505 is YES, then the first data file is offloadable, and method 500 may proceed to register (operation 512) a new record for the first data file in the offload mapping. Following operation 512, method 500 may proceed to operation 602 in method 600 (see FIG. 6). It is noted that files resident in local storage resource 150 that do not have an entry in offload mapping 300 may be referred to as pinned files.

Referring now to FIG. 6, a block diagram of selected elements of an embodiment of method 600 for offloading data as describe herein is depicted in flowchart form. Method 600 may be performed using data location management agent 212 and offload mapping 300 (see FIGS. 2 and 3) for example. As shown, method 600 may represent a particular embodiment of certain portions of method 400, such as operations 406, 408 (see FIG. 4). It is noted that certain operations described in method 600 may be optional or may be rearranged in different embodiments.

Method 600 may begin with a decision whether, as a result of a pending file access operation, an available capacity is less than a specified reserve capacity of the local storage resource (operation 602). In operation 602, the available capacity may be adjusted for a storage capacity needed for a new file or an update to a previously stored file. When the result of operation 602 is YES, a plurality of data files may be selected (operation 604) for offloading based on a least-recently-used (LRU) algorithm. It is noted that when a previously offloaded file has not been locally modified, copying the previously offloaded file to remote storage may be omitted, for example, by excluding the previously offloaded file from the plurality of data files for offloading selected in operation 604. In certain embodiments, individual files may be selected in operation 604. Then, the plurality of data files may be offloaded (operation 606) to the remote storage location. Offloading in operation 606 may include copying a data file from the local storage resource to the remote storage resource and verifying that a valid copy of the data file is stored on the remote storage resource. Operation 606 may also include deleting a data file from the local storage resource. In certain embodiments, offloading in operation 606 may include deleting files having certain file types, for example, as identified by a particular file extension, when an application file that generates files having the file types is deleted. It is noted that in certain embodiments, the data location management agent may perform operation 604 and instruct another entity (e.g., another program and/or another processor) to perform operation 606 to improve performance of the information handling system on which the data location management agent is executing. When the result of operation 602 is NO, a decision may be made whether the access operation is a write operation (operation 608). When the result of operation 608 is NO, the first data file may be loaded from the remote storage resource (operation 610). When a pending file access operation is a write operation, an offloaded file may not be retrieved from the remote storage resource, since the offloaded file may be overwritten with the write operation. When the result of operation 608 is YES, after operation 606, and/or after operation 610, method 600 may update (operation 614) existing record(s), when present, for the first data file in the offload mapping. In operation 614, an entry in offload mapping 300 corresponding to the first data file may be updated. It is noted that a pinned file would not have an entry in offload mapping 300 and would result in no action being taken at operation 614. After operation 614, method 600 may return to operation 404 in method 400 (see FIG. 4).

As described in detail above, disclosed methods and systems for offloading data to a remote storage resource from a local storage resource on an information handling system may involve using a data location management agent and an offload mapping. The data location management agent may detect requests for access to files stored on a file system and may offload files to the remote storage resource to maintain a specified available capacity of the local storage resource, based on at least in part on the offload mapping. The data location management agent may classify certain files as pinned files that are excluded from offloading.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method executed by at least one processor comprising:
detecting, by a data location management agent installed on an information handling system, a request to access a first data file intended for a local storage resource included with the information handling system;
when the first data file is currently stored at a remote storage resource accessible to the information handling system:
offloading at least a second data file to the remote storage resource, including deleting the second data file from the local storage resource; and
loading the first data file from the remote storage resource to the local storage resource.

2. The method of claim 1, further comprising:
prior to detecting the request, enabling configuration of the data location management agent, including:
determining a network location of the remote storage resource; and
determining a reserve capacity of the local storage resource.

3. The method of claim 2, wherein offloading at least the second data file is performed when the available capacity of the local storage resource is less than the specified reserve capacity.

4. The method of claim 1, further comprising:
determining whether the first data file is an offloadable file;
when the data file is an offloadable file:
registering the first data file in an offload mapping; and
restricting offloading of data files to the remote storage resource to files registered in the offload mapping.

5. The method of claim 4, wherein the request to access the first data file is handled by a first file system installed on the local storage resource, and wherein determining whether the first data file is an offloadable file further comprises:
determining, based on one or more file attributes of the first data file whether the first data file is a pinned file, wherein a pinned file is not an offloadable file, and wherein the file attributes are selected from:
whether a file is resident in the local storage resource and is not included in the offload mapping;
a file extension;
a file location in the first file system;
whether a file includes executable code;
attributes of secondary files associated with a file; and
a security attribute assigned by an operating system installed on the information handling system.

6. The method of claim 4, wherein registering the first data file in the offload mapping includes:
when the offload mapping includes a record for the first data file, modifying the record, including updating a timestamp attribute for the first data file; and
when the offload mapping does not include a record for the first data file:
creating a new record for the first data file in the offload mapping;
recording metadata in the new record, the metadata including:
a filename associated with the first data file;
a first location of the first data file on the local storage resource; and
a second location of the first data file on the remote storage resource.

7. The method of claim 1, wherein offloading at least the second data file includes offloading a plurality of data files, including the second data file, and wherein the plurality of data files are selected according to a least-recently-used algorithm.

8. An article of manufacture comprising a non-transitory computer-readable medium storing instructions, that, when executed by a processor subsystem, cause the processor subsystem to:
instantiate a data location management agent on an information handling system, the data location management agent enabled to:
detect a request to access a first data file intended for a local storage resource included with the information handling system;
when the first data file is currently stored at a remote storage resource accessible to the information handling system:
offload at least a second data file to the remote storage resource, including deleting the second data file from the local storage resource; and
load the first data file from the remote storage resource to the local storage resource.

9. The article of manufacture of claim 8, wherein, prior to detecting the request, the data location management agent is enabled to:
determine a network location of the remote storage resource; and
determine a reserve capacity of the local storage resource,

10. The article of manufacture of claim 9, wherein the data location management agent is enabled to offload at least the second data file responsive to determining that an available capacity of the local storage resource is less than the reserve capacity.

11. The article of manufacture of claim 8, wherein the data location management agent is enabled to:
determine whether the first data file is an offloadable file;
when the data file is an offloadable file:
register the first data file in an offload mapping; and
restrict offloading of data files to the remote storage resource to files registered in the offload mapping.

12. The article of manufacture of claim 11, wherein the request to access the first data file is handled by a first file system installed on the local storage resource, and wherein the data location management agent enabled to determine whether the first data file is an offloadable file includes the data location management agent enabled to:
determine, based on one or more file attributes of the first data file whether the first data file is a pinned file, wherein a pinned file is not an offloadable file, and wherein the file attributes are selected from:
whether a file is resident in the local storage resource and is not included in the offload mapping;
a file extension;
a file location in the first file system;
whether a file includes executable code;
attributes of secondary files associated with a file; and
a security attribute assigned by an operating system installed on the information handling system.

13. The article of manufacture of claim 11, wherein the data location management agent enabled to register the first data file in the offload mapping includes the data location management agent enabled to:
when the offload mapping includes a record for the first data file, modify the record, including updating a timestamp attribute for the first data file; and
when the offload mapping does not include a record for the first data file:
create a new record for the first data file in the offload mapping;
record metadata in the new record, the metadata including:
a filename associated with the first data file;
a first location of the first data file on the local storage resource; and
a second location of the first data file on the remote storage resource.

14. The article of manufacture of claim 8, wherein the data location management agent enabled to offload at least the second data file includes the data location management agent enabled to offload a plurality of data files, including the second data file, and wherein the plurality of data files are selected according to a least-recently-used algorithm.

15. An information handling system comprising:
a processor subsystem having access to a memory subsystem, wherein the memory subsystem stores instructions executable by the processor subsystem, that, when executed by the processor subsystem, cause the processor subsystem to:
instantiate a data location management agent on an information handling system, the data location management agent enabled to:
detect a request to access a first data file intended for a local storage resource included with the information handling system;
when the first data file is currently stored at a remote storage resource accessible to the information handling system:
offload at least a second data file to the remote storage resource, including deleting the second data file from the local storage resource; and
load the first data file from the remote storage resource to the local storage resource.

16. The information handling system of claim 15, wherein, prior to detecting the request, the data location management agent is enabled to:
determine a network location of the remote storage resource; and
determine a reserve capacity of the local storage resource,

17. The information handling system of claim 16, wherein the data location management agent is enabled to offload at least the second data file responsive to determining that an available capacity of the local storage resource is less than the reserve capacity.

18. The information handling system of claim 15, wherein the data location management agent is enabled to:
determine whether the first data file is an offloadable file;
when the data file is an offloadable file:
register the first data file in an offload mapping; and
restrict offloading of data files to the remote storage resource to files registered in the offload mapping.

19. The information handling system of claim 18, wherein the request to access the first data file is handled by a first file system installed on the local storage resource, and wherein the data location management agent enabled to determine whether the first data file is an offloadable file includes the data location management agent enabled to:
determine, based on one or more file attributes of the first data file whether the first data file is a pinned file, wherein a pinned file is not an offloadable file, and wherein the file attributes are selected from:
whether a file is resident in the local storage resource and is not included in the offload mapping;
a file extension;
a file location in the first file system;
whether a file includes executable code;
attributes of secondary files associated with a file; and
a security attribute assigned by an operating system installed on the information handling system.

20. The information handling system of claim 18, wherein the data location management agent enabled to register the first data file in the offload mapping includes the data location management agent enabled to:
when the offload mapping includes a record for the first data file, modify the record, including updating a timestamp attribute for the first data file; and
when the offload mapping does not include a record for the first data file:
create a new record for the first data file in the offload mapping;
record metadata in the new record, the metadata including:
a filename associated with the first data file;
a first location of the first data file on the local storage resource; and
a second location of the first data file on the remote storage resource.

21. The information handling system of claim 15, wherein the data location management agent enabled to offload at least the second data file includes the data location management agent enabled to offload a plurality of data files, including the second data file, and wherein the plurality of data files are selected according to a least-recently-used algorithm.
